(19) United States
(12) Patent Application Publication
(10) Pub. No.: US 2022/0207007 A1
(43) Pub. Date: Jun. 30, 2022

(54) ARTIFICIALLY INTELLIGENT MASTER DATA MANAGEMENT

(71) Applicant: Vision Insight AI LLP, Pune (IN)

(72) Inventors: Ajay Solanki, Pune (IN); Rahul Kumar Pandey, Pune (IN); Aishit Dharwal, Pune (IN)

(21) Appl. No.: 17/178,492

(22) Filed: Feb. 18, 2021

(30) Foreign Application Priority Data
Dec. 30, 2020 (IN) 202021057185

(51) Int. Cl. G06F 16/215; G06F 16/21; G06F 16/2455; G06F 16/22; G06F 16/25; G06N 3/08

(52) U.S. Cl. CPC G06F 16/215; G06F 16/213; G06N 3/08; G06F 16/2282; G06F 16/258; G06F 16/24553

(57) ABSTRACT

A method and system for creating an industry specific master data. The method includes receiving data files from a user. The method further includes automatically cleaning the data files by removing garbage data, junk characters, missing data, and non-printable characters to obtain clean data. Further, creating an industry specific dictionary from the clean data. The industry specific dictionary is enriched upon determining relationships between keywords present in the clean data. The method further includes mapping the keywords present in the industry specific dictionary with external data sources to obtain mapped data using Deep Learning techniques. Further, determining common rows present across the clean data and the mapped data. The common rows are determined by data tables present in the clean data and the mapped data. Finally, creating industry specific master data upon merging unique columns present in the data tables.

### PRIORITY INFORMATION

The present application claims priority from the Indian patent application numbered 202021057185 filed on Dec. 30, 2020 in India.

### TECHNICAL FIELD

The present subject matter described herein, in general, relates to population of data records in a database management system.

### BACKGROUND

In recent times, the importance of data management in enterprises has increased significantly. As a result, the enterprises have started hiring companies for managing data. These companies pull data from multiple data sources for the enterprise and place it into another database. However, the process of pulling out data and placing it into another database is time-consuming and requires a lot of manpower. Currently, there are many enterprise-based data management software programs to get access to existing data created in different departments to fill out and process. It has been observed that there is still a need for an improved system for managing data for different enterprises with an accuracy.

### SUMMARY

Before the present system(s) and method(s), are described, it is to be understood that this application is not limited to the particular system(s), and methodologies described, as there can be multiple possible embodiments which are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for creating an industry specific master data. This summary is not intended to identify essential features of the claimed subject matter nor is it intended for use in determining or limiting the scope of the claimed subject matter.

In one embodiment, a method for creating an industry specific master data is disclosed. In order to create the industry specific master data, initially, an industry specific dictionary may be created from external data sources using Deep Learning techniques. The external data sources may comprise internet and open source repositories. Further, data files may be received from a user. The data files may comprise files stored in the local database such as excels, documents, CSVs, google analytics stats, cloud-data, Microsoft azure data, and others. Further, the data files may be automatically cleaned by removing garbage data, junk characters, missing data, and non-printable characters to obtain clean data. Upon automatically cleaning, the industry specific dictionary may be enriched from the clean data. It may be noted that the industry specific dictionary may be enriched upon determining relationships between keywords present in the clean data using the Deep Learning techniques. Subsequently, common rows present across different tables of the clean data may be mapped based on a similarity score of a row pair and a column pair across the different tables. The similarity score may be computed using the deep learning models on embeddings generated by the enriched industry specific dictionary. The common rows are mapped from data tables present in the clean data. Finally, industry specific master data may be created upon merging unique columns present in the data tables. It may be noted that the unique columns are linked with the common rows. In one aspect, the aforementioned method for creating an industry specific master data may be performed by a processor using programmed instructions stored in a memory.

In another embodiment, a non-transitory computer-readable medium embodying a program executable in a computing device for creating an industry specific master data is disclosed. The program may comprise a program code for creating an industry specific dictionary from external data sources using Deep Learning techniques. The external data sources may comprise internet and open source repositories. Further, the program may comprise a program code for receiving data files from a user. The data files may comprise files stored in the local database such as excels, documents, CSVs, google analytics stats, cloud-data, Microsoft azure data and others. Further, the program may comprise a program code for automatically cleaning the data files by removing garbage data, junk characters, missing data, and non-printable characters to obtain clean data. Subsequently, the program may comprise a program code for enriching the industry specific dictionary from the clean data. The industry specific dictionary may be enriched upon determining relationships between keywords present in the clean data using the Deep Learning techniques. Subsequently, the program may comprise a program code for mapping common rows present across different tables of the clean data. The common rows may be mapped based on a similarity score of a row pair and a column pair across the different tables. The similarity score may be computed using the deep learning models on embeddings generated by the enriched industry specific dictionary. The common rows may be mapped from data tables present in the clean data. Finally, the program may comprise a program code for creating industry specific master data upon merging unique columns present in the data tables. It may be noted that the unique columns are linked with the common rows.

### BRIEF DESCRIPTION OF THE DRAWINGS

The foregoing detailed description of embodiments is better understood when read in conjunction with the appended drawings. For the purpose of illustrating of the present subject matter, an example of a construction of the present subject matter is provided as figures, however, the invention is not limited to the specific method and system for creating an industry specific master data disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

FIG. 1 illustrates a network implementation for creating an industry specific master data, in accordance with an embodiment of the present subject matter.

FIG. 2 illustrates a method for creating an industry specific master data, in accordance with an embodiment of the present subject matter.

The figure depicts an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “creating,” “receiving,” “cleaning,” “enriching,” “mapping,” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The present subject matter discloses a method and a system for creating industry specific master data. It is important to note that the an industry specific dictionary is created from external data sources. The external data sources may comprise the internet and open source repositories. The industry specific dictionary is different for different domains. The industry specific dictionary plays a vital role in accuracy of any data modelling system. If the industry specific dictionary has junk or garbage files, it may affect the overall accuracy of the data modelling system. Thus, the present invention receives data files from the user in order to create the industry specific dictionary. The data files may be HTML, excels, documents, PDFs, CSVs, and google analytics stats, cloud-data, Microsoft azure data, and others. Further, the system automatically cleans the data files by removing garbage information to obtain clean data. Further, the system enriches the industry specific dictionary from the clean data to create the industry specific master data.

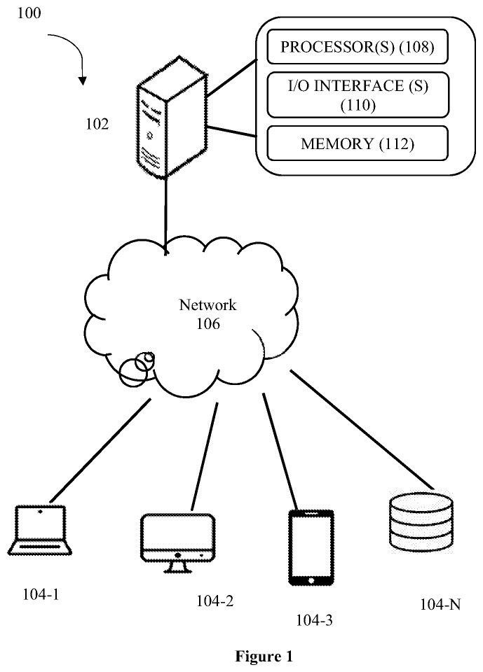

Referring now to FIG. 1, a network implementation 100 of a system 102 for creating an industry specific master data is disclosed. Initially, the system 102 creates an industry specific dictionary form external data sources using Deep Learning Techniques. Further, the system receives data files from the user. In an example, the data files may be available on a user device 104-1. It may be noted that the data files may be present in plurality of devices or data repositories. The system may access one or more user devices 104-2, 104-3 . . . 104-N, collectively referred to as user devices 104, hereinafter, or applications residing on the user devices 104.

Although the present disclosure is explained considering that the system 102 is implemented on a server, it may be understood that the system 102 may be implemented in a variety of computing systems, such as a laptop computer, a desktop computer, a notebook, a workstation, a virtual environment, a mainframe computer, a server, a network server, a cloud-based computing environment. It will be understood that the system 102 may be accessed by multiple users through one or more user devices 104-1, 104-2 . . . 104-N. In one implementation, the system 102 may comprise the cloud-based computing environment in which the user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, the system 102 may include at least one processor 108, an input/output (I/O) interface 110, and a memory 112. The at least one processor 108 may be implemented as one or more microprocessors, microcomputers, microcontrollers, digital signal processors, Central Processing Units (CPUs), state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the system 102 to interact with the user directly or through the client devices 104. Further, the I/O interface 110 may enable the system 102 to communicate with other computing devices, such as web servers and external data servers (not shown). The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, Solid State Disks (SSD), optical disks, and magnetic tapes. The memory 112 may include routines, programs, objects, components, data structures, etc., which perform particular tasks or implement particular abstract data types. The memory 112 may include programs or coded instructions that supplement applications and functions of the system 102. In one embodiment, the memory 112, amongst other things, serves as a repository for storing data processed, received, and generated by one or more of the programs or the coded instructions.

As there are various challenges observed in the existing art, the challenges necessitate the need to build the system 102 for creating an industry specific master data. At first, a user may use the user device 104 to access the system 102 via the I/O interface 110. The user may register the user devices 104 using the I/O interface 110 in order to use the system 102. In one aspect, the user may access the I/O interface 110 of the system 102. The detail functioning of the system 102 is described below with the help of figures.

The present subject matter describes the system for creating industry specific master data. The system 102 creates an industry specific dictionary from external data sources using Deep Learning Techniques. The Deep Learning Techniques may include, but not limited to, Deep Neural Network, long short-term memory (LSTM), Bidirectional Encoder Representations from Transformer (BERT), and FastText. The external data sources may comprise the internet and open source repositories. It may be noted that the industry specific dictionary varies from industry to industry.

Further to creating the industry specific dictionary, the system receives data files from a user. The data files may comprise files stored in the local database such as excels, PDFs, HTML, documents, CSVs, and google analytics stats, cloud-data, Microsoft azure data, and others. It may be noted that the data files may be stored at cloud platforms or different user devices. In one embodiment, the system automatically pulls out the data files when installed on the device or an enterprise server.

Further to receiving the data files, the system 102 may automatically clean the data files by removing garbage data, dirty data, junk characters, missing data, punctuations, and non-printable characters to obtain clean data. The user may validate the clean data. Further, the user has an option to retain the clean data or the data files. In an example, the system automatically cleans the data files to obtain the clean data. Further, in the example, the user deletes the data file and retains the clean data obtained from the system. In one embodiment, the system identifies incomplete, incorrect, inaccurate, or irrelevant parts of the data. Further, the system modifies or deletes the garbage data to obtain the clean data.

Further to automatically cleaning, the system 102 may enrich the industry specific dictionary from the clean data. The industry specific dictionary is enriched upon determining relationships between keywords present in the clean data using the Deep Learning techniques. The relationship between the keyword may be determined by using the Named Entity Recognition technique. Further, the relationships between the keywords may be determined by a relationship score. The keywords are embedded using a FastText or a Bidirectional Encoder Representations from Transformer (BERT) to obtain embedded keywords. Further, the Euclidean distance or the Cosine Similarity may be computed between the embedded keywords. Furthermore, the relationship score may be computed from the Euclidean distance or the Cosine Similarity. The relationship score is determined for all keywords with each other. In one embodiment, sentence embedding may also be performed to distinguish between two or more sentences. For example, sentence embedding may also be performed to distinguish between sentence A and sentence B.

In an embodiment, a Graph Neural Networks (GNN) model may be used enrich the industry specific dictionary from the clean data. It may be noted that the GNN model may use a vertex, an edge and a connectivity between the graphs to learn enriching or embedding. The connectivity refers to relation between two graphs (herein the industry specific dictionary and the clean data). Each keyword may be presented as a vertex in the graph. In an implementation, a keyword A and a keyword B are connected with an edge representing a relationship between the keyword A and the keyword B. It may be noted that the objective is to pretrain the GNN model for individual vertex and graph. The above process is used for iteratively training the GNN model based on the industry specific dictionary and the clean data.

In an embodiment, the GNN model uses a neighbourhood aggregation approach, where relationship of the keyword is iteratively updated by aggregating relationships of the keyword's neighbouring vertex and edges.

In an embodiment, the GNN model may be pretrained using at least one of a Context Prediction, an Attribute Masking, and a graph-level supervised pretraining (Supervised Attribute Prediction).

It may be noted that the FastText is a library for learning of word embeddings and text classification. The FastText helps to create unsupervised learning or supervised learning algorithms for obtaining vector representations for words. The Bidirectional Encoder Representations from Transformer (BERT) is Artificial Intelligent (AI) enabled ranking algorithm. The FastText and the BERT help to understand the context of the query. In the present invention, the FastText and the BERT are used for understanding the relationship between the keywords

In one embodiment, the keywords are represented graphically. A keyword is a vertex or a node of a graph. The system may create the graph of all the keywords present in the clean data. Each keyword may be presented as a vertex in the graph. Consider an example in which the system receives a data file. The system cleans the data file to obtain clean data. Further, the system enriches the industry specific dictionary upon determining relationships between keywords present in the clean data. In the example 10 keywords (A, B, C, D, E, F, G, H, I, J) are present. The system creates the graph of 10 keywords. An edge between A and B in the graph represents a relationship between A and B. Further, the edge contains a value (between 0 to 1) which represents a relationship score between A and B. Further, the relationship score is determined from the Cosine Similarity or the Euclidean distance (Distance between A and B in this case) of the FastText or BERT embeddings of the two keywords. Further, the industry specific dictionary maintains the relationship score of 10 keywords with each other. In the example, the industry specific dictionary represents the graph with vertices as the keywords and edges as the relationship score between the keywords.

The relationship score between A and other keywords is shown in table 1. The table shows that the relationship score between A (vertex 1) and B (vertex 2) is 0.8. Similarly, the industry specific dictionary maintains the relationship score of all the keywords with each other.

TABLE 1

| Vertex 1 | Vertex 2 | Relationship Score |
|---|---|---|
| A | B | 0.8 |
| A | C | 0.9 |
| A | D | 0.89 |
| A | E | 0.75 |
| A | F | 0.8 |
| A | G | 0.9 |
| A | H | 0.8 |
| A | I | 0.8 |
| A | J | 0.9 |

The system continuously enriches the industry specific dictionary when new data files or the clean data is received. It may be noted that the graph also keeps updating in background. In one embodiment, the system 102 pulls out the keywords from the clean data that are present in the clean data in high quantity. It may be noted that the industry specific dictionary varies from industry to industry.

Further to enriching the industry specific dictionary, the system 102 may map common rows present across different tables of the clean data. The common rows may be mapped based on a similarity score of a row pair and a column pair across the different tables. The similarity score is computed using the deep learning models on the embeddings generated by the enriched industry specific dictionary. The common rows are mapped from data tables present in the clean data. It may be noted that the mapped data is obtained using Deep Learning Techniques such as Deep Neural Network, Long short-term memory (LSTM), Bidirectional Encoder Representations from Transformer (BERT), and FastText.

Consider an example, assuming two tables (Table 2 and Table 3) are present in the clean data. The system maps common rows (‘A B’ and ‘C D’ in this case) present across Table 2 and Table 3 of the clean data. The common rows are mapped based on the similarity score of a row pair and a column pair present across Table 2 and Table 3. The similarity score of the row pair (‘A B’ and ‘A B X’) is computed. In the example, the similarity score of the row pair (‘A B’ and ‘A B X’) is 70%. Similarly, the similarity score of each row pair is computed. Further, the similarity score of a column pair (‘A C’ and ‘A C E’) is computed. In the example, the similarity score of the column pair (‘A C’ and ‘A C E’) is 65%. Similarly, the similarity score of each column pair is computed.

TABLE 2

| | |
|---|---|
| A | B |
| C | D |

TABLE 3

| | | |
|---|---|---|
| A | B | X |
| C | D | Y |
| E | F | Z |

Further to mapping common rows, the system 102 may create industry specific master data upon merging unique columns present in the matched data tables. The unique columns are linked with the common rows. The unique columns may be merged when a similarity score between the common row and a row having the unique columns is above a threshold value. In the example, the predefined threshold for unique rows is 65%.

Considering previous example, the unique column is ‘X Y Z’. The system merges the unique column with the common rows ‘A B’ and ‘C D’ to create an industry specific master data.

TABLE 4

| | | |
|---|---|---|
| A | B | X |
| C | D | Y |

In order to elucidate further, consider an example wherein the clean data comprises Table A and Table B. Table A comprises rows for Customer Name, Contact Number and Address. Table B comprises rows for Customer Name, Address and Fax Number. The system 102 determines that the common rows are Customer Name and Address. Further, the unique columns present in the matched data tables are Contact Number and Fax Number. The system 102, then merges the unique columns (Contact Number and Fax Number in this case) along with the common rows to create the industry specific master data. Thus, the industry specific master data comprises columns Customer Name, address, Contact Number and Fax Number.

Consider another example, the clean data comprises Table C and Table D. Table C comprise rows A, B, C, D, E. Table D comprise rows A, C, X, Y, Z. The system will compute the similarity score of a row pair and a column pair across the Table C and Table D. Further, the system maps the common rows (A and C) present in the Table C and the Table D. Furthermore, the unique columns present in the matched data tables are B, D, E, X, Y. When the similarity score of the row pair having the unique columns is above threshold value the unique columns are merged to obtain the industry specific master data. In one implementation, the predefined threshold value may be set by the user.

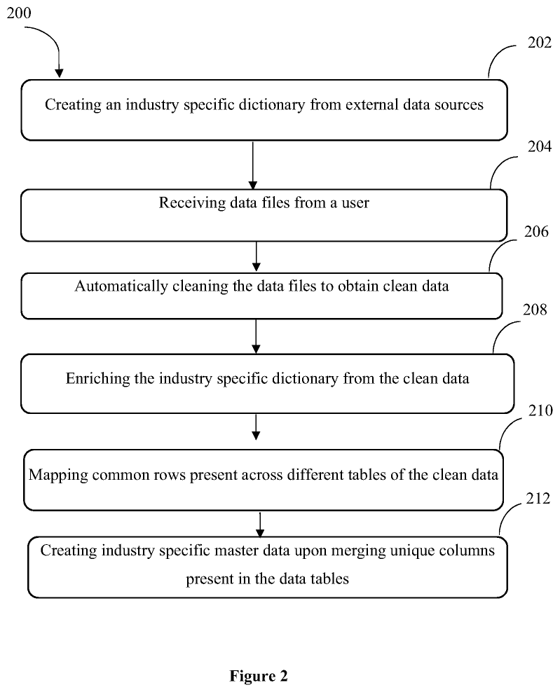

Referring now to FIG. 2, a method 200 for creating an industry specific master data is shown, in accordance with an embodiment of the present subject matter. The method 200 may be described in the general context of computer executable instructions. Generally, computer executable instructions can include routines, programs, objects, components, data structures, procedures, modules, functions, etc., that perform particular functions or implement particular abstract data types.

The order in which the method 200 is described is not intended to be construed as a limitation, and any number of the described method blocks can be combined in any order to implement the method 200 or alternate methods for creating an industry specific master data. Additionally, individual blocks may be deleted from the method 200 without departing from the scope of the subject matter described herein. Furthermore, the method 200 for creating an industry specific master data can be implemented in any suitable hardware, software, firmware, or combination thereof. However, for ease of explanation, in the embodiments described below, the method 200 may be considered to be implemented in the above-described system 102.

At block 202, an industry specific dictionary may be created from external data sources using Deep Learning techniques. The external data source may comprise internet and open source repositories. In one implementation, the industry specific dictionary may be stored in the memory 112.

At block 204, the data files may be received from the user. The data files may comprise files stored in the local database such as excels, PDFs, HTMLs, documents, CSVs, and google analytics stats, cloud-data, Microsoft azure data and others. In one implementation, the data files may be stored in the memory 112.

At block 206, the data files may be automatically cleaned by removing garbage data, dirty data, junk characters, missing data, punctuations, and non-printable characters. In one implementation, the cleaned data files may be stored in the memory 112.

At block 208, the industry specific dictionary may be enriched from the clean data. The industry specific dictionary may be enriched upon determining relationships between keywords present in the clean data using the Deep Learning techniques. In one implementation, the enriched industry specific dictionary may be stored in the memory 112

At block 210, the keywords present in the industry specific dictionary may be mapped with external data sources to obtain mapped data. The external data sources may comprise internet and open source repositories. It may be noted that the mapped data is obtained using Deep Learning Techniques. In one implementation, the mapped data may be stored in the memory 112.

At block 210, common rows present across different tables of the clean data may be mapped. The common rows may be mapped based on a similarity score of a row pair and a column pair across the different tables. The similarity score may be computed using the deep learning models on embeddings generated by the enriched industry specific dictionary.

At block 212, an industry specific master data may be created upon merging unique columns present in the data tables. In one implementation, the industry specific master data may be stored in the memory 112.

Exemplary embodiments discussed above may provide certain advantages. Though not required to practice aspects of the disclosure, these advantages may include those provided by the following features.

In some embodiments, the system and methods help the user to create an industry specific master data without any human intervention.

Some embodiments of the system and method help the user or an enterprise to find out the relation between the data files with the external data sources.

Some embodiments of the system and method help the user to obtain clean data from the data files. It may be noted that the clean data do not contain any duplicate entries.

Some embodiments of the system and method helps the user to merge or link the data files when columns in two data files are not in the same order. The system uses Deep Learning Models for merging or linking.

Some embodiments of the system and method helps the user to merge or link the data files of different formats without human intervention.

Some embodiments of the system and method provide the user a choice for retaining at least the clean data, the data files provided by the user, or both.

Although implementations for methods and system for creating an industry specific master data have been described in language specific to structural features and/or methods, it is to be understood that the appended claims are not necessarily limited to the specific features or methods described. Rather, the specific features and methods are disclosed as examples of implementations for creating an industry specific master data.

We claim:

1. A method for creating an industry specific master data, the method comprising:
creating, by a processor, an industry specific dictionary from external data sources using Deep Learning techniques;
receiving, by the processor, data files from a user;
automatically cleaning, by the processor, the data files by removing garbage data, junk characters, missing data, and non-printable characters to obtain clean data;
enriching, by the processor, the industry specific dictionary from the clean data, wherein the industry specific dictionary is enriched upon determining relationships between keywords present in the clean data using the Deep Learning techniques;
mapping, by the processor, common rows present across different data tables of the clean data based on a similarity score of a row pair and a column pair across the different data tables, wherein the similarity score is computed using the deep learning models on embeddings generated by the enriched industry specific dictionary, and wherein the common rows are mapped from data tables present in the clean data; and
creating, by the processor, industry specific master data upon merging unique columns present in the data tables, wherein the unique columns are linked with the common rows.

2. The method as claimed in claim 1, further comprises validating the clean data by the user, wherein the user has an option to retain the clean data or the data files.

3. The method as claimed in claim 1, wherein the keywords are represented graphically, and wherein a keyword is a vertex of the graph.

4. The method as claimed in claim 1, wherein the data files comprise files stored in the local database such as excels, documents, CSVs, and google analytics stats, cloud-data, Microsoft azure data and others.

5. The method as claimed in claim 1, further comprising the relationship between the keyword is determined by using Named Entity Recognition technique.

6. The method as claimed in claim 1, wherein the relationship between the keywords is determined by a relationship score, and wherein the relationship score is computed based on a Euclidean Distance or a Cosine Similarity.

7. The method as claimed in claim 1, further comprises training the industry specific dictionary based on the mapped data and the clean data using the Artificial Intelligence (AI).

8. The method as claimed in claim 1, wherein the unique columns are merged when a similarity score of the row pair having the unique columns is above a threshold value.

9. A system for creating an industry specific master data, the system comprising:
a memory; and
a processor coupled to the memory, wherein the processor is configured for:
receiving data files from a user;
receiving data files from a user;
automatically cleaning the data files by removing garbage data, junk characters, missing data, and non-printable characters to obtain clean data;
enriching the industry specific dictionary from the clean data, wherein the industry specific dictionary is enriched upon determining relationships between keywords present in the clean data using the Deep Learning techniques;
mapping common rows present across different data tables of the clean data based on a similarity score of a row pair and a column pair across the different data tables, wherein the similarity score is computed using the deep learning models on embeddings generated by the enriched industry specific dictionary, and wherein the common rows are mapped from data tables present in the clean data; and
creating industry specific master data upon merging unique columns present in the data tables, wherein the unique columns are linked with the common rows.

10. A non-transitory computer program product having embodied thereon a computer program for creating an industry specific master data, the computer program product storing instructions, the instructions for:
creating an industry specific dictionary from external data sources using Deep Learning techniques;
receiving data files from a user;
automatically cleaning the data files by removing garbage data, junk characters, missing data, and non-printable characters to obtain clean data;
enriching the industry specific dictionary from the clean data, wherein the industry specific dictionary is enriched upon determining relationships between keywords present in the clean data using the Deep Learning techniques;
mapping common rows present across different data tables of the clean data based on a similarity score of a row pair and a column pair across the different data tables, wherein the similarity score is computed using the deep learning models on the embeddings generated by enriched industry specific dictionary, and wherein the common rows are mapped from data tables present in the clean data; and
creating industry specific master data upon merging unique columns present in the data tables, wherein the unique columns are linked with the common rows.
